(19) United States
(12) Patent Application Publication
(10) Pub. No.: US 2014/0284932 A1
(43) Pub. Date: Sep. 25, 2014

(54) TURBINE GENERATOR

(71) Applicants: Suleiman Mahmoud Sharkh, Southampton (GB); Alan Fraser, Crowthorne (GB); Michael Andrew Yuratich, Hamble (GB); Stephen Richard Turnock, Wareham (GB)

(72) Inventors: Suleiman Mahmoud Sharkh, Southampton (GB); Alan Fraser, Crowthorne (GB); Michael Andrew Yuratich, Hamble (GB); Stephen Richard Turnock, Wareham (GB)

(73) Assignee: University of Southampton, Southamton, Hampshire (GB)

(21) Appl. No.: 14/233,833

(22) PCT Filed: Aug. 9, 2012
(86) PCT No.: PCT/GB2012/051935

§ 371 Date: May 29, 2014

(30) Foreign Application Priority Data
Aug. 9, 2011 (GB) 1113694.2

(51) Int. Cl. F03B 13/00; F03D 9/00

(52) U.S. Cl. CPC F03B 13/00; F03D 9/002
USPC 290/54

(57) ABSTRACT

The invention relates to the generation of electricity from flowing fluid and in the preferred embodiment to a horizontal axis turbine and generator assembly. The present invention is applicable to water turbines and the invention is described in relation to this application. It is however to be appreciated that it is applicable to wind turbines. The present invention provides turbine generator for generating electrical power from flowing fluid comprising a rotatable hub having an external surface and a rotational axis arranged, in use, parallel to the direction of the flow, a plurality of blades mounted on the external surface of the hub and extending radially outwards from the hub; a plurality of magnets mounted on a surface inside the rotatable hub said surface arranged to rotate with the rotatable hub thereby forming a rotor of an electrical generator, and a plurality of non-rotating coils fixed to a stationary cylindrical core within the periphery of the rotatable hub, said coils and core thereby forming a stator of the electrical generator.

### BACKGROUND

1. Technical Field of the Invention

The invention relates to the generation of electricity from flowing fluid and in the preferred embodiment to a horizontal axis turbine and generator assembly. The present invention is applicable to water turbines and the invention is described in relation to this application. It is however to be appreciated that it is applicable to wind turbines.

2. Description of Related Art

Climate change, pollution and energy security are the major problems of our time and addressing them requires a significant change in energy infrastructure. Renewable energy sources are essential in this respect and fossil fuels are gradually being replaced by clean, non-depletable sources of energy. Among these sources are the flow of wind and water across the earth's surface. The dominant method of extracting energy from these flows is by producing electricity using turbine generators.

The power per unit area available from a fluid flow is proportional to the density of the fluid, and the cube of the speed of the fluid. The energy density of water is about 1000 times that of air and hence, for typical water and wind speeds, the energy per unit area available from a water stream is about 8 times that available from wind. Marine currents, caused by tidal and river flows, have the potential to supply over 12 GW of power in the EU. Around the world, and in the third world in particular, the exploitation of this natural resource for the generation of electricity, desalination, water purification, irrigation and other uses could make a significant contribution to improving the quality of life with little environmental impact.

Marine currents are highly predictable, both in terms of direction and flow rate, which makes them attractive as an energy source. However, marine current generators have to cope with harsh underwater conditions which can make them expensive to deploy and operate. In all generators efficiency needs to be maximised in order to reduce the cost of the electricity produced. A further design consideration is the increased cost of maintaining offshore underwater equipment and therefore reliability is paramount.

Wind turbine technology is well developed and the inclination of marine turbine providers has been to adapt wind turbines for use underwater. Conventional generators run at high speeds to reduce the torque load and it is common to use a gearbox to convert the relatively slow rotational speed of the turbine to the high rotational speed required by the generator. Such a turbine is manufactured by Marine Current Turbines and is described in GB 2347976. However, the mechanical complexity of the gearbox reduces reliability and decreases efficiency.

The size of an electrical generator is proportional to its torque capability. Conventionally, the size of the generator and hence cost are reduced by using a gear box to speed up the generator. Since power equals torque times speed, an increase in speed means a reduction in torque for a given power. However, as mentioned above a bulky gearbox reduces the overall efficiency, which is generally compensated for by having longer blades to capture more energy from the water. However, this increased blade length, together with the added mass of the gearbox may offset the generator size and cost savings. The longer blades will not just simply increase the mass of the blades, which would need to be thicker to withstand the higher forces, they will also increase the overall thrust loading of the turbine, thus requiring bulkier blade root support structures as well as a bulkier overall support structure to hold the turbine in place.

Wind flows often change direction and horizontal axis wind turbines can track this change by allowing the turbine to yaw about a vertical axis. Tidal flows ebb and flow in only two directions. This can be tracked by allowing the assembly to yaw about a vertical axis, or by actively controlling the pitch of the blades to allow the turbine to rotate in the reverse direction. Both solutions introduce complexity to the system and therefore decreased reliability and efficiency. There is therefore a need for an improved turbine having bi-directional operation.

Patent application WO 03025385 to Clean Current discloses a generator and turbine arrangement having a direct drive rim generator. The rotor has a number of blades with magnets at the tips of the blades (fitted on a steel yoke), where a duct forms the stator housing. However, the duct is a large and costly component which increases the thrust loading on the device and therefore increases the cost of the supporting structure. The rim also increases the stress forces on the blades which can bend significantly if they are thin. The breakage of a blade in a turbine with a rim would be more serious than a turbine without a rim because the unbalance forces are more severe.

Therefore a need exists for an efficient, low cost, bidirectional marine current generator with low maintenance requirements and a minimal number of moving parts.

### SUMMARY OF THE INVENTION

In an aspect of the present invention there is provided a turbine generator for generating electrical power from flowing fluid comprising a rotatable hub having an external surface and a rotational axis arranged, in use, parallel to the direction of the flow, a plurality of blades mounted on the external surface of the hub and extending radially outwards from the hub; a plurality of magnets mounted on a surface inside the rotatable hub said surface arranged to rotate with the rotatable hub thereby forming a rotor of an electrical generator and a plurality of non-rotating coils fixed to a stationary cylindrical core within the periphery of the rotatable hub, said coils and core thereby forming a stator of the electrical generator. The plurality of coils are connected to form multiple separate groups of coils to provide an m-phase output. The plurality of coils are further connected to form a plurality of separate isolated sets of said multiple groups of coils so as to provide a corresponding plurality of m-phase outputs.

This direct drive generator does not require a gearbox and therefore the assembly can be mechanically very simple, having only one major moving part, the rotor. The turbine generator may be suitable for generating electricity from either liquid or air flow. Permanent magnets may be used to improve the efficiency of the generator. The turbine generator may be used in tidal flows; the blades may have a symmetrical cross-sectional profile so that they are operable in both forward and reverse directions, for example, in a tidal stream. Preferably, the blades comprise two aerofoil sections arranged back to back to form a peanut-shaped, cross-sectional profile where each aerofoil section will generate lift in a particular direction of rotation such that they are rotationally symmetrical and the turbine generator operates efficiently in both forward and reverse fluid flow thereby permitting bi-directional operation. The turbine generator can be fixed in place, such that the turbine reverses with reversing flow without the need for it to yaw to re-align with the reversed flow direction. Both ends of the stator may be supported by a frame or one end of the stator may be supported by a support arm.

The gap between the stator and the rotor may be filled with fluid such as oil, or with water from the environment in which the turbine is located. If the fluid is water the stator and rotor may be encapsulated in a waterproof layer, of for example polyurethane or other epoxy material, to seal them against water in the gap.

The cylindrical core of the stator may be hollow to define a cavity within the cylindrical core. The cavity may provide a thermal expansion chamber for the oil in the gap between the stator and the rotor. Alternatively the cavity may be air-filled or foam filled which can make the assembly more buoyant and therefore reduce the size and weight of the support structure when the turbine generator is installed near the water surface, for example attached to a pier. The cavity may house the control electronics. The core may be laminated and the laminations formed of an edge-wound spiral strip of steel. The core may have a plurality of slots on its outer surface running in an axial direction, wherein each portion of the core between adjacent slots forms a raised tooth and each of the plurality of coils are wound around one or more of the raised teeth. The slots may be skewed and/or the magnets may be skewed to reduce cogging torque.

The plurality of coils may be connected in three separate groups to provide a three-phase output. In an embodiment the plurality of separate isolated sets of coils is connected to independent power electronic converters that may be connected in series or parallel. This provides increased fault tolerance and reduces output filter requirements. The power electronic converters may comprise rectifiers. For the case of a 3-phase arrangement, with two isolated sets of coils, the coils may be configured such that the two sets of coils generate outputs that are phase-shifted by 30 degrees and respectively connected to two 6-pulse rectifiers to result in a rectified output having 12 pules every cycle.

A generator control means may be provided comprising a coil output monitoring means for monitoring the output of at least one of the coils and a control unit for controlling the reacted torque to the coils in dependence on the output of the monitoring means to maximise the power output for a given water flow rate and/or to stall the turbine if a maximum rotational speed is exceeded.

Preferably, the rotatable hub has an internal surface and the magnets are mounted on the internal surface of the rotatable hub itself. This embodiment is compact and mechanically simple (with associated cost and reliability benefits) compared to conventional turbine and generator assemblies. However, in certain applications where, for example, the rotors might be rotating at a low speed but with high torque (e.g. a water turbine with larger blades or a wind turbine) it is advantageous to include a gear box to ‘gear-up’ the rotation speed of the generator rotor in order for the generator to function efficiently. Accordingly, in other embodiments a magnetic gear assembly is provided which is arranged about the generator rotor and operable to gear-up rotation of the generator rotor with respect to rotations of the rotating hub. Having the generator rotor inside the rotatable hub of the turbine permits easy integration of a magnetic gear assembly into the turbine generator. Although increasing the overall mechanical complexity, relative to embodiments where the magnets are mounted on the internal surface of the rotatable hub itself, this arrangement still retains a size/cost benefit compared to conventional turbine and generator arrangements. As a magnetic gearbox is used, rather than a mechanical gearbox, the efficiency and reliability is also improved relative to conventional systems. The magnetic gear can be designed to increase the speed of the generator rotor according to the design requirements of marine or wind based generator turbines.

In embodiments the magnetic gear assembly comprises a plurality of stationary ferromagnetic pole pieces disposed between the generator rotor and the outer hub and a gear outer rotor, comprising a plurality of gear outer rotor magnets, arranged on the internal surface of the rotatable hub. The number of generator rotor magnets is less than the number of gear outer rotor magnets. Preferably, the gear outer rotor magnets are arranged to interact with the generator rotor magnets through the stationary ferromagnetic pole pieces such that the generator rotor rotates with increased speed and lower torque than the gear outer rotor thereby gearing-up rotation of the generator rotor with respect to rotations of the rotating hub.

In another embodiment, the magnetic gear assembly further comprises a gear inner rotor comprising a plurality of gear inner rotor magnets, disposed between the generator rotor and the stationary ferromagnetic pole pieces. The gear inner rotor magnets are arranged to interact with the gear outer rotor magnets through the stationary ferromagnetic pole pieces such that the gear inner rotor rotates at a greater speed and lower torque than the gear outer rotor. In this embodiment, the generator rotor is connected to the gear inner rotor such that the generator rotor rotates with the gear inner rotor thereby gearing-up rotation of the generator rotor with respect to the rotations of the rotating hub.

The number of magnets in the magnetic gear assembly preferably adheres to the relationship:

$$i . G = \frac{mP}{mP + {kn}_{s}}$$

where G is a predetermined gearing ratio of outer rotor speed to inner rotor speed, P is the number of magnet pole pairs on the inner rotor of the magnetic gear, m=1, 2, 3, . . . and k=0±1±2± . . . , and nₛ is the number of ferromagnetic pieces.

In a further aspect according to the present invention there is provided a method of operating a turbine generator measuring a change in output power produced by at least one coil of the generator thereby determining whether the output power is increasing, measuring the speed of rotation of the rotor of the generator and tracking the maximum output power by drawing more power from the generator coils if it is determined that the output power is increasing with increasing or decreasing rotor speed.

The method may further comprise increasing the output power rapidly in order to stall the turbine if the output power or rotor speed exceeds a predetermined value.

### BRIEF DESCRIPTION OF THE DRAWINGS

Embodiments of the present invention are described below, by way of example only, with reference to the accompanying drawings, in which:

FIG. 1a shows a perspective view of the complete turbine generator assembly;

FIG. 1b shows a projection of the turbine generator assembly of FIG. 1a;

FIG. 1c shows a plan view of the turbine generator assembly of FIG. 1a;

FIG. 2 shows a detailed view of a blade of the turbine generator in FIG. 1a;

FIG. 3 is a view of the generator part of the turbine generator assembly shown in FIG. 1a;

FIG. 4 is a cross sectional view of the generator part of the turbine generator assembly of FIG. 3;

FIG. 5 is a view of an embodiment where the stator is supported at only one end by a support arm;

FIG. 6a is a cross sectional view of a portion of the stator and the rotor of the turbine generator shown in FIG. 1a;

FIG. 6b is a cross sectional view of the stator and the rotor of the turbine generator shown in FIG. 1a;

FIG. 7a is a schematic representation of the control electronics for the turbine generator shown in FIG. 1a having three groups of connected coils;

FIG. 7b is a schematic representation of the control electronics for the turbine generator shown in FIG. 1a, having three groups of three coils connected together to provide multiple independent sections;

FIG. 8 is a graph showing the dependency of power output and torque on the rotational speed of the turbine for various stream speeds;

FIG. 9 is a cross sectional view of the turbine generator which includes a magnetic gear assembly;

FIG. 10 is a schematic representation of a generator connected to a three-phase 6-pulse rectifier;

FIG. 11 is a screenshot of a typical three-phase generator voltage waveform (top) and a 6-pulse rectifier output waveform (bottom);

FIG. 12 is a schematic representation of a generator with two 3-phase windings, phase shifted by 30 degrees, connected to a 12-pulse rectifier;

FIG. 13 is a screenshot of a generator voltage waveform (top) and 12-pulse rectifier output waveform (bottom);

FIG. 14 is a schematic representation of a cogging-reducing arrangement;

FIG. 15 is a schematic representation of an arrangement that would experience cogging;

FIG. 16 is another schematic representation of an arrangement that would experience cogging; and

FIG. 17 is another schematic representation of a cogging-reducing arrangement.

### DETAILED DESCRIPTION OF THE PREFERRED EMBODIMENT

The power available from water current is proportional to the cube of the current speed. For tidal currents close to the shoreline in estuaries, and in channels between mainland and islands, the speed varies approximately sinusoidally with time, with a period relating to the different tidal components. Sites of most interest for exploitation have a maximum current speed in excess of 1.5 m/s, for example the Bristol Channel in the UK has a current speed of 2.5 m/s. Rivers can flow at speeds of up to 3.5 m/s and this can be increased further by damming.

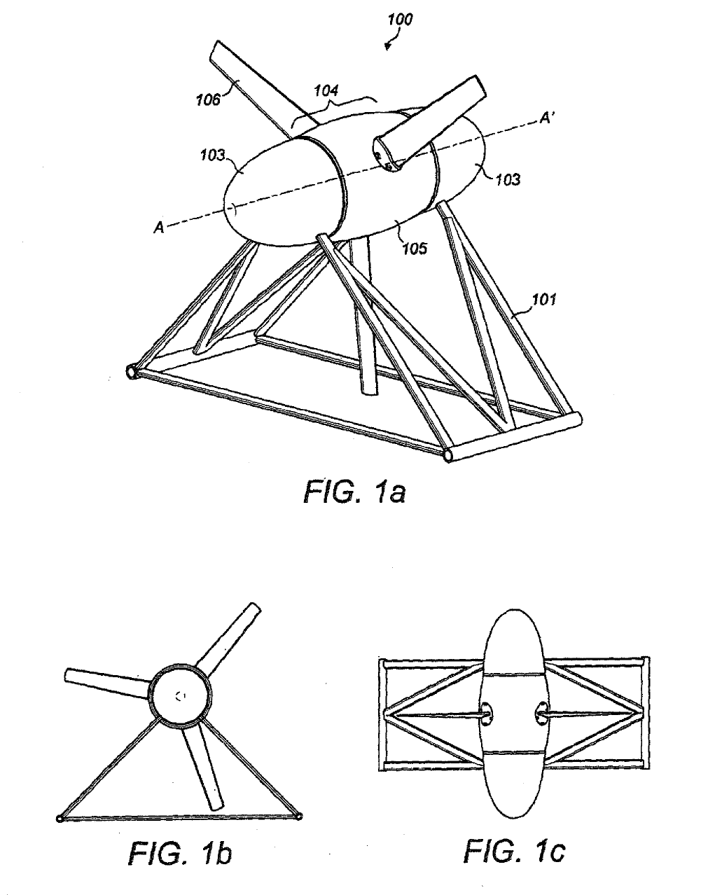

FIG. 1 is a view of a fluid turbine assembly 100 in accordance with an embodiment of the invention, suitable for extracting energy from flowing water, either tidal or river flows. The assembly comprises a cradle 101 supporting a hydro-dynamically efficient ellipsoidal structure. The ellipsoidal structure has a major axis A-A′ which, when the assembly is installed, is orientated such that it is generally aligned with the fluid flow direction. The ellipsoidal structure is formed of a pair of static nose cones 103 and a central barrel-shaped generator 104. The cradle 101 is connected to the structure at the nose cones 103 which are provided to reduce drag forces and thrust loading on the structure and to improve efficiency. The generator 104, located between the nose cones 103, has an outer housing 105 which is rotatable about the major axis A-A′ of the ellipsoidal structure. The outer housing 105 of the generator is of a bulging cylindrical shape, having its greatest diameter mid-way along its length, at a point corresponding to the equator of the ellipsoidal structure. The ellipsoidal structure is symmetrical about this mid-way point. Three blades 106 are attached to the housing 105 of the generator 104 and extend radially outwards away from the housing 105. It will be understood that although this example shows three blades the turbine could be constructed with a different number of blades with a minimum of two blades required. The three blades 106 are arranged symmetrically around the circumference of greatest diameter on the housing 105 of the generator 104. The diameter of the circle traced by the tip of the blades is 2.1 metres. The diameter of the generator 104 is 0.53 metres.

The size of the electric generator is related to its cost and therefore its size is kept to a minimum. The outer diameter of the generator body is less than around 25% of the overall diameter of the turbine to reduce blockage of fluid flow by the generator body, and to minimize the loss of active turbine area. Therefore the blades are arranged to be as long as possible, although the contribution to power generation of the blades sections near the roots is very small compared to that of the outer blade sections. However, reducing the size of the generator for given output torque and power reduces its efficiency, which could be compensated for by increasing the diameter of the blades and power captured from the water. A compromise between electric generator size and cost, and overall size and cost of the turbine and its supporting structure is therefore struck.

The assembly may be installed in any location where there is flowing water, including tidal flows and rivers. The assembly may be secured to the sea or river bed either by resting on pre-prepared piles or a structure secured in place by gravity, or may be tethered in place. Alternatively, the assembly may be located close to the surface and mounted on a pole or floating pontoon or even a boat.

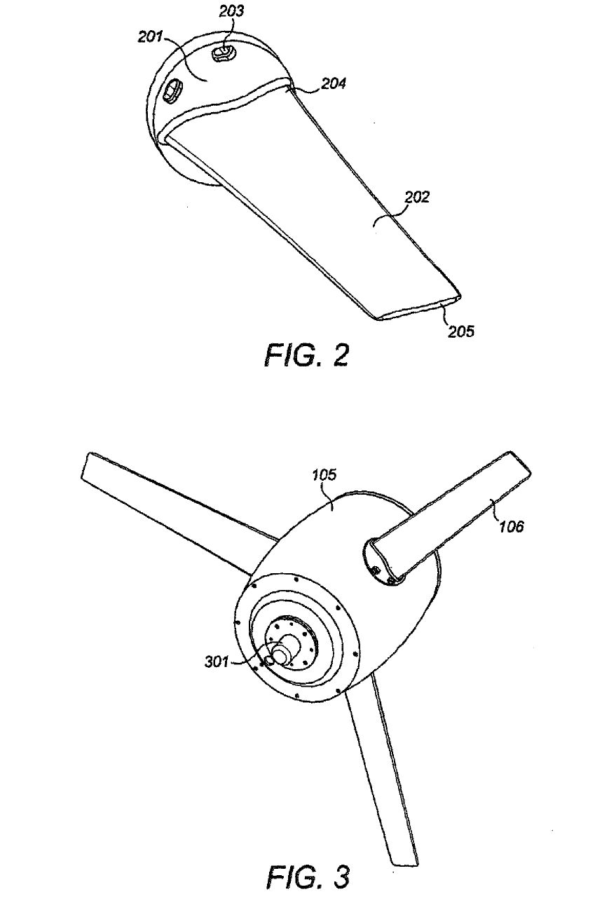

FIG. 2 is a view of a blade 106 according to an embodiment of the invention. The blade 106 includes a mounting plate 201 and a blade element 202. The mounting plate is disc-shaped and engages with a circular recess in the generator housing 105. The blade element 202 is a generally planar structure which extends perpendicularly away from the mounting stub 201. The blade element 202 has a root 204 and a tip 205. The centre line of the blade element 202 is aligned with the centre of the mounting stub 201. The width of the blade element 202 at the root is substantially equal to the diameter of the mounting plate 201, and tapers to approximately 50% of the root width at the tip 205. Preferably, two aerofoil sections are arranged back to back to form a peanut shaped cross-section such that each aerofoil section will generate lift in a particular direction of rotation, and hence the blade is rotationally symmetrical. The proportions of the sections are carefully selected to ensure efficient operation, with a typical thickness to chord ratio of 0.1 for the outer sections of the blades.

As the blade profile is rotationally symmetrical the blades operate with equal efficiency in both directions; this allows bi-directional operation of the blades. A twist may be introduced along the length of the blade. The mounting plate has four slotted holes 203 for receiving fastening bolts (not shown). The slots allow the blade 106 to be rotated about a central axis and thus the pitch of the blades can be adjusted during the initial set-up of the turbine. The length and pitch of the blades is selected based on the expected speed of the water flow and is a factor in determining the rotation speed of the blades for a given flow rate. The mounting plate 201 and blade element 202 are cast as a single unit and machined to finish.

The location of the blades 106 at the mid-point of the housing, and the symmetrical geometry of the blades 106 allows bi-directional operation of the fluid turbine without significant degradation of performance in either direction. This greatly simplifies the construction of the supporting structure because the generator does not have to be turned 180 degrees about a vertical axis when the flow direction changes.

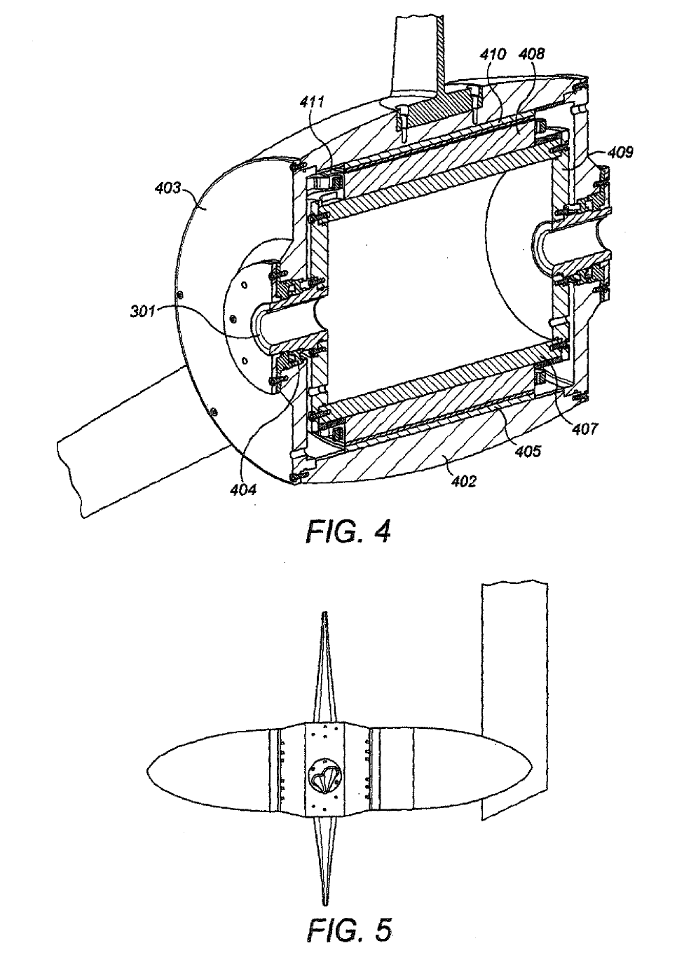

The generator 104 is comprised of the rotating housing 105, caused to rotate by water flowing past the blades 106, and a static axle 301, shown in FIG. 3. The axle 301 is supported and fixed in place at each end by suitable clamps (not shown) in the nose cones 103. FIG. 4 shows the generator in more detail. The housing 105 comprises a rotor drum 402 with end plates 403, defining an internal space. The drum 402 has an external surface, which includes the circular recesses for the blades 106 and an internal surface to which an arrangement of magnets 405 are attached. The magnets 405 (and a cylindrical steel yoke behind them as well as the drum) form the rotor of the generator. The end plates 403 have a central orifice for housing bearing units 404. The axle 301 shown in FIG. 3 comprises two short hollow cylindrical axle stubs supporting a stator chassis 407, as shown in FIG. 4. The axle stubs engage with the bearing units 404 allowing the housing 105 to rotate about the axle 301. The bearing units 404 are sealed. The stator chassis 407 includes a cylindrical stator core 408 and end plates 409. The stator core 408 is co-axial with the rotor drum 402. The stator is mounted around the outside of the stator chassis 407. The diameter of the stator chassis 407 and the thickness of the stator 408 are chosen to provide a gap 410 between the outer surface of the stator 408 and the inner surface of the magnets 405.

The gap may be an air gap, in which case the bearing units 404 are tightly sealed against the ingress of water; the seal must be capable of withstanding the water pressure at the depth at which the assembly is operated. Alternatively the gap may be filled with oil which can balance the external water pressure and therefore removes the need to tightly seal the bearings. Thermal expansion of the oil is accommodated by providing an expansion chamber, for example within the stator cavity. Alternatively, the seal can be omitted, allowing water into the gap. In this instance the rotor and stator are encapsulated in protective material to prevent corrosion; this requires a larger gap between the stator and rotor which can reduce the efficiency of the generator.

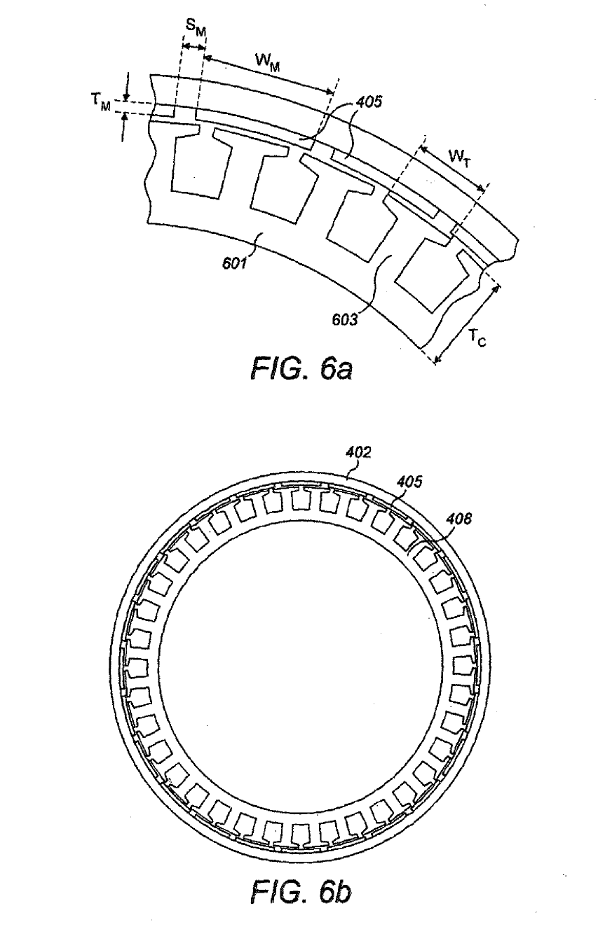

The rotor 411 comprises four steel rings, positioned side-by-side and lining the inner surface of the rotor drum 402. Each ring has a number N_{M} of equally spaced, rare-earth permanent magnets fixed to the interior surface. The magnets are thin and arcuate in shape to conform to the shape of the stator. The magnets 405 are shown in FIG. 6a, and have thickness T_{M} of 0.5 cm and width W_{M} of 3.9 cm in an embodiment. The magnets are spaced apart by a distance S_{M} of 1.8 cm. The length of each magnet is selected so that magnets in neighbouring rings abut each other. The dimensions W_{M} and S_{M} are selected to complement the dimensions of the stator and to reduce cogging, as described in more detail below.

The stator 408 includes a laminated slotted core 601 wound with copper wire coils. The stator core 601 is a cylindrical sleeve which slips over the stator chassis 407 and is substantially co-terminous with the chassis. The stator core 601 is equal in length to the rotor 410. FIGS. 6a and 6b show the stator 408 and the rotor 410 in cross section. The laminations of the stator comprise a thin strip of metal having a number N_{T} of undercut teeth 603 for receiving the coil windings. The teeth have a width W_{T} of 2.7 cm and the core has a thickness T_{c} of 4 cm.

In this embodiment N_{M}=24 and N_{T}=36, which are selected so that a concentrated winding can be used, with each coil wound around one tooth, thus simplifying the winding process. Another advantage of the concentrated winding is that the end windings are relatively short, compared to a lap winding for example, which reduces the corresponding copper loss. This combination of the number of teeth and poles also has the advantage of having a reduced cogging torque. Cogging torque is due to the interaction of the permanent magnets of the rotor with the stator teeth and presents a minimum start-up torque required to get the rotor moving. It is desirable to reduce this torque in order to capture all of the available energy even from a slow-moving flow of water. This is particularly important for tidal flows where a significant proportion of the daily flow is around zero as flows reverse. Cogging torque in electric machines is caused by the tendency of the magnets to align with the teeth to shorten the flux path and achieve minimum energy. This could also be thought of in terms of forces between common harmonics of magnet flux and slot permeance. For example, in a 24 pole machine the flux due to the magnet will vary periodically and will have a fundamental component with a space period of 1 pole pitch, i.e. around the machine periphery there will be 12 cycles of flux corresponding to the 12 pairs of north-south magnets. The resulting periodic variation of flux around the periphery of the rotor will have a fundamental component (12 cycles around the periphery) as well as odd harmonics (36 cycles for the 3rd harmonic and 60 cycles for the 5th and so on). If the machine has 36 slots, the permeance variation will have a fundamental component with a period equal to a slot pitch, i.e. there will be 36 permeance cycles around the periphery in addition to other odd harmonics. The amplitude of the harmonics decreases as their order increases. Cogging torque results from the interaction of common magnet flux and slot permeance harmonics. Cogging can be reduced if these harmonics are reduced or eliminated.

Skewing either the rotor or the stator can be used to reduce cogging so that different parts of a given magnet will be urged in opposing directions, thus cancelling out cogging torque. But skewing reduces the voltage generated by the machine, and its power output for a given size. It also increases losses.

Another method is to use a fractional number of teeth per pole; a whole number of teeth per pole results in high cogging torque. However, this does not entirely eliminate cogging.

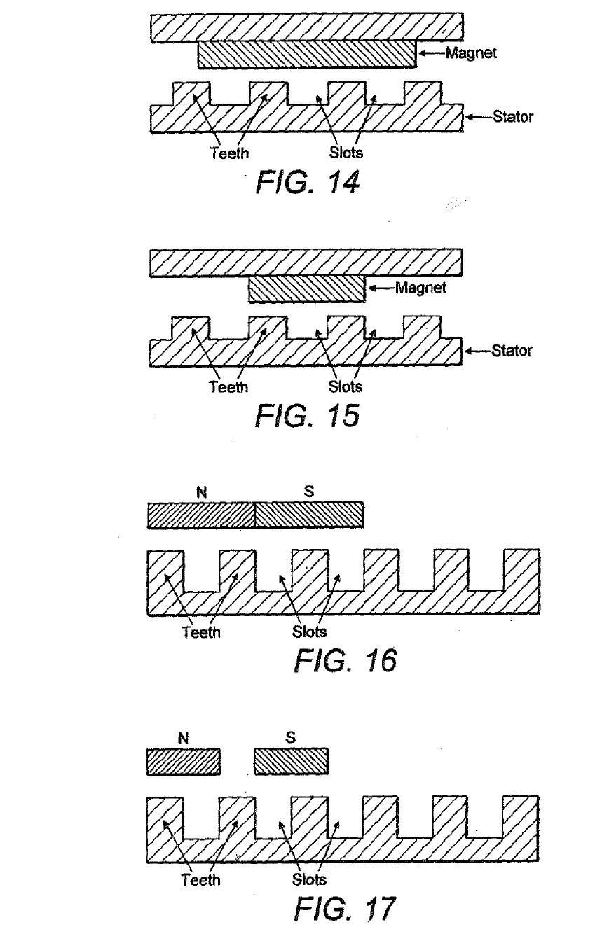

An alternative is to adjust the width of the teeth and the magnets such that the magnets always see the same proportions of steel teeth and slots, as illustrated in FIG. 14. In FIG. 14, the magnet will always see 3 teeth and 3 slots regardless of its position and hence it will experience no cogging force. However in FIG. 15, if the magnet is moved from its current position, it will see fewer teeth and more slots, and thus it will experience a cogging force that will try to bring it back into alignment with the teeth.

Another way of looking at this is to think of the cogging force to be generated as a result of the interaction of the common harmonics of the magnets and teeth-slot permeance. The magnetic field in the gap will not be sinusoidally distributed. It will have a fundamental component with a period equals to the distance between two similar poles (known as pole pitch). In addition it will have other harmonics with shorter periods. It can be thought of as several pairs of magnets with different widths on top of each other, each producing sinusoidal flux. The widest magnet will produce the fundamental flux and the narrower magnets will produce the harmonics. Like a string on a musical instrument, there will be a fundamental vibration of the whole string, in addition to vibrations by shorter parts of the spring, which give the instruments their rich distinctive sounds.

Similarly, the variation of the permeance to magnetic flux of the tooth-slot structure, i.e. the ease of flow of flux can be thought of in the same way. The steel is more permeable to flux than slots, i.e. the magnetic flux flows easier into the teeth than into the slot regions. This can be represented by a permeance waveform showing peaks under the teeth and troughs under the slots. Such a variation is not normally sinusoidal, and hence it will have a fundamental component and its harmonics. The common harmonics of magnet flux and permeance will interact, i.e. they will attract each other, resulting in cogging. If the strong common harmonics are eliminated then cogging will be reduced.

Consider a machine with 24 poles and 36 slots. There are 1.5 slots per pole, or 3 slots every 2 poles. FIG. 16 below illustrates a 2-pole section of the machine. The north pole will see 2 teeth and one slot, while the south pole will see 2 slots and one pole, and the rotor will resist moving from this position. But if the magnets' widths are reduced to ⅔ as illustrated in FIG. 17, each magnet will see one slot and one tooth at any time and cogging will be eliminated (in this simple theory).

The above simple theory neglects magnet flux fringing, that is the spreading of the magnet flux sideways beyond its width, which means in practice the ratio of magnet width to pole pitch needs to be slightly different.

In terms of harmonics, the magnet flux density has a fundamental cycle with period of 1 pole pitch, while the permeance has 3 cycles every pole pitch. Thus, a 3rd harmonic of the magnet flux could interact with the fundamental harmonic of the permeance variation. The third harmonic of the magnet flux could be imagined as 6 little magnets spread over the 2 main magnets in a north-south order with the main north pole having an additional small north in the middle and two small souths on either side, and the main south pole having an additional south in the middle and a north on either side. These will tend to align themselves with the teeth thus causing cogging. When the magnets' widths are reduced, this third harmonic is eliminated. But higher order harmonics may still cause some cogging.

The above ideas can be extended to other machines with different number of slots and teeth.

So rotor skewing can be achieved by either having specially moulded magnets that are already skewed or by making each pole from a number of straight magnet segments, which are staggered relative to each other. The desired skew angle αₛₖ, in electrical degrees, to cancel the fundamental cogging torque components can be approximated from the following equation:

$${α}_{sk} = \frac{2 n π}{k}$$

where n=1, 2, . . . and k is the common harmonic order (taking the period of the fundamental harmonic to be one pole pitch).

An alternative to skewing is to adjust the slot opening and/or the magnet width such that common harmonics are eliminated. The ratio β of the magnet width to half pole pitch can be estimated using the following formula:

$$β = m \frac{2 P}{{N}_{s}} - M$$

$$0 < β < 1$$

$$M = 1 , 2 , … , 2 P - 1 , \\ m = 0 , 1 , … , {N}_{s} - 1$$

And the ratio α of tooth width to slot pitch can be estimated using the following formula:

$$α = M \frac{{N}_{s}}{P} - m$$

$$0 < α < 1$$

$$M = 1 , 2 , … , 2 P - 1 , \\ m = 0 , 1 , … , {N}_{s} - 1$$

Exact values are determined using finite element analysis. In this embodiment the following approximate values are used:

α=2/3

β=2/3

The relatively large diameter stator laminations have a thin back of core and narrow teeth. A conventional stamping process to produce a large number of these laminations is expensive, as the central cut-out disk would be waste. In an embodiment of the invention the stator laminations are formed from a single strip, with slots stamped out of steel of preferably 0.5 mm thickness. Alternative thicknesses include 0.35 mm or 0.65 mm. The strip is edge wound under tension on a mandrel that is smaller in diameter than the final diameter of the helical lamination. A helical thread-like groove is machined on the surface of the mandrel to guide the steel strip and prevent it from its natural tendency to bend flat. The wound strip is left on the mandrel for several hours to even stress distribution, before removing it from the threaded small diameter mandrel and clamping it on a mandrel of the correct larger diameter. The whole assembly is then normalised at high temperature.

In order to reduce cogging torque further the teeth spacing can be offset slightly so that the finished wound laminations have a skew.

Each tooth 603 of the stator core 601 supports a coil of copper wire. The number of turns and the diameter of the coil's wire are selected in dependence on the output current and voltage required. In order to decrease the size of the generator the current density in the winding can be increased by reducing the coil copper cross-section to a minimum. However, this will increase copper losses and reduce the efficiency of the generator.

A three-phase output is preferred because this provides a smoother DC output voltage, when connected to a rectifier. To obtain a three-phase output the coils are connected in groups of three, i.e. in the generator shown in FIG. 6b a coil is connected to a subsequent coil three teeth away. This concentrated winding arrangement keeps the end windings short which reduces the cost of copper, improves efficiency and reduces end winding overlap, as discussed earlier.

Normally, the windings of a synchronous generator are connected in a 3-phase configuration, and the power is supplied to the grid through three terminals at constant voltage and frequency of 50 or 60 Hz. In this case, the speed of the generator and therefore the output voltage frequency is held constant by a speed regulator.

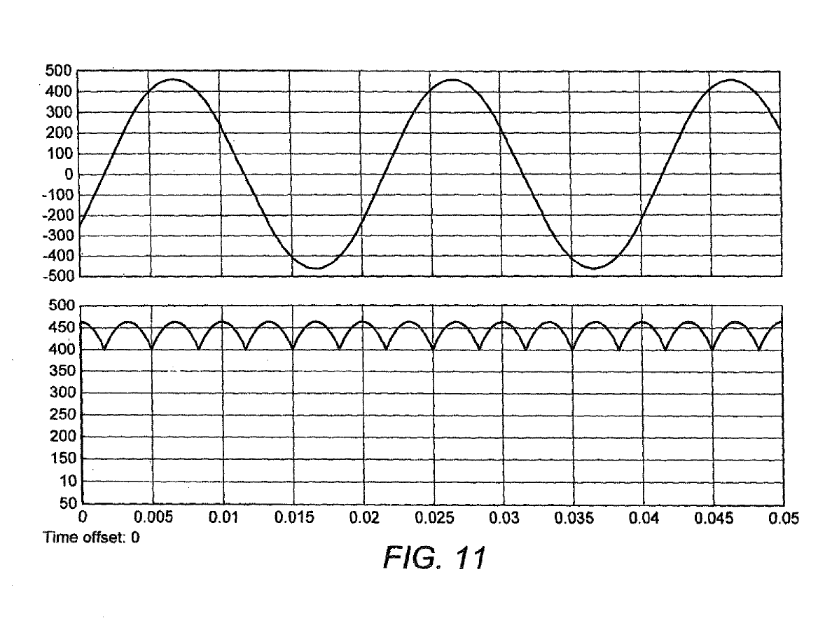

However, the speed of marine turbines, with fixed pitch blades, varies with the speed of water current, and so, accordingly, does the frequency and the voltage of the alternating current (ac) electricity produced by the generator. This is normally overcome by rectifying the alternating current (ac) output of the generator to change it into direct current (dc) as shown in FIG. 10. The output voltage of the rectifier will have a ripple (variation around a mean value) at 6 times the frequency of the generator, as shown in FIG. 11, and for this reason this rectifier is known as a 6-pulse rectifier. This ripple is normally filtered out using a capacitor before it is connected to the load. The load may be a resistor as shown in FIG. 10, or more commonly, a dc-dc converter followed by an inverter (dc/ac converter) that changes the dc to fixed voltage and fixed frequency ac that is fed into the grid.

A known method for reducing the rectifier output voltage ripple is to connect the generator's output to a transformer with two secondary windings connected respectively in Y and delta configurations. The outputs from each of the windings is connected to its own 6-pulse rectifier. The output terminals of the rectifier are connected either in parallel or in series. Because the output voltages of the Y and delta windings are phase shifted by 30 degrees, the dc voltage ripple will have a frequency that is 12 times that of the generator, and its amplitude will be half that of the 6-pulse rectifier. As a result, the filter capacitor will be smaller and cheaper. However, this come at the expense of the additional transformer.

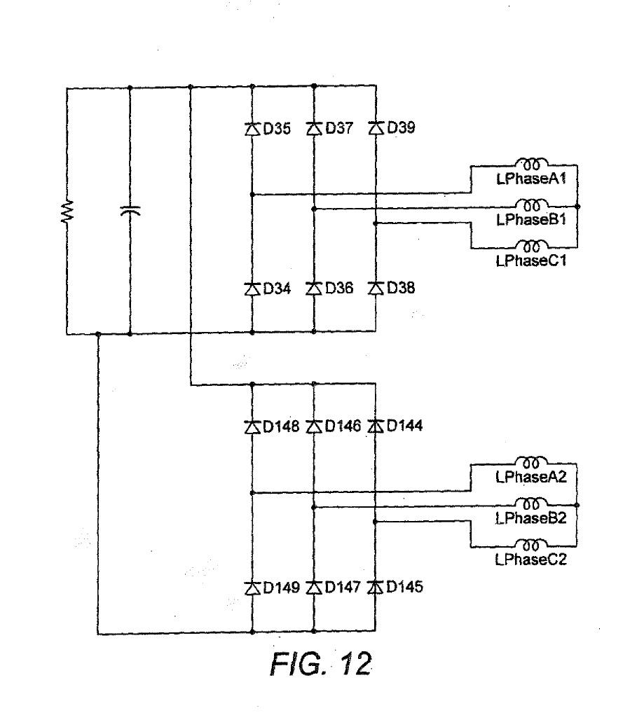

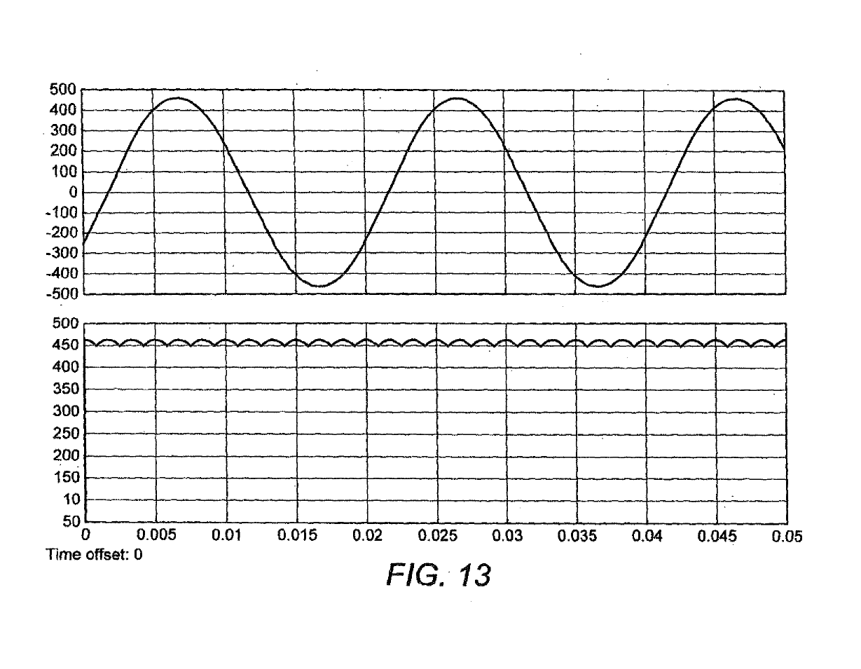

The cost of such an additional transformer can be saved by reconfiguring the winding of the machine into two sets of 3 phases with a phase shift of 30 degrees between them. This is possible by careful selection of the machine's number of slots per pole. For example a two pole machine with 12 slots, has an angle of 30 degrees between the slots. The voltages generated in conductors in adjacent slots will therefore have a phase difference of 30 degrees. Two sets of three-phase windings could be placed: one using the odd numbered slots, and the other using the even numbered slots. The voltages generated in these two windings will have a phase difference of 30 degrees. Thus when they are connected to two 6-pulse rectifiers whose dc output terminals are connected in series or in parallel, the rectified dc voltage ripple will have 12 pulses every cycle and its amplitude will be halved. FIG. 12 shows a circuit diagram of a machine with two sets of 3-phase windings connected a 12-pulse rectifier, and FIG. 13 shows the output waveform with higher frequency lower amplitude voltage ripple than that of the 6-pulse rectifier.

This idea could be extended to have more sets of m-phase windings (m being the number of phases; 3 is common, but other number of phases is also possible) with suitable values of phase shift to reduce the voltage ripple and the cost of the filter capacitor further.

The reliability of the generator 104 can also be improved by configuring the winding into several isolated three-phase sections. For example, in the embodiment of FIG. 6b each phase group of 12 coils could be further split into 3 separate groups; therefore there are 3 isolated 3 phase groups windings, i.e. there are 9 outputs from the generator. In this multiple isolated winding arrangement, redundancy is provided in that if there is a fault in one of the coil groups, that winding could be disconnected and power could still be provided by the other 2 coil groups. This improves the reliability and the availability of the supply.

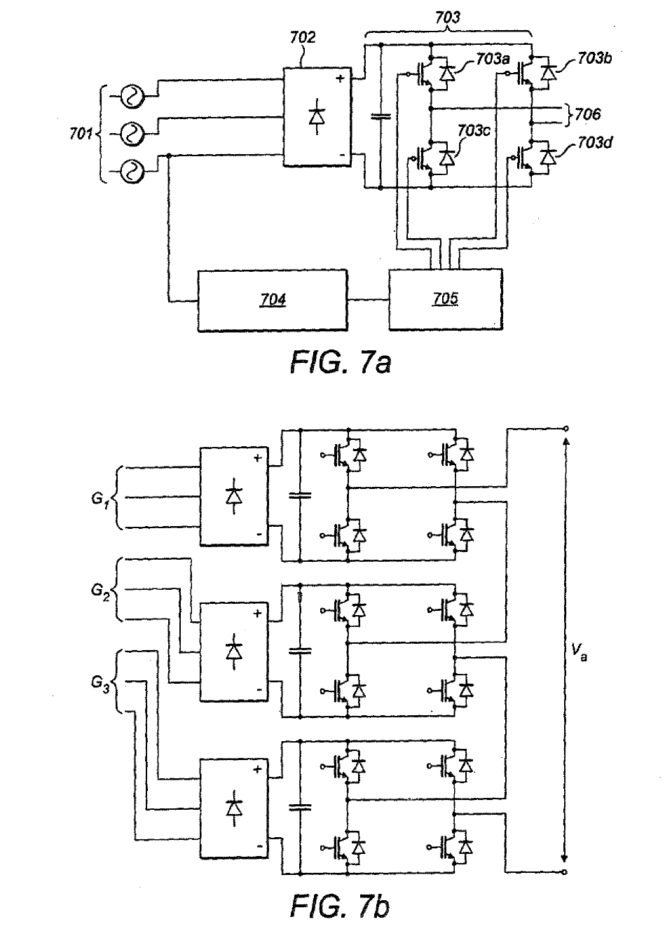

The coils are connected to power conditioning electronics, shown in FIG. 7a. The variable speed of the water flow produces a variable speed of rotation of the turbine blades and thus of the rotor about the stator. The output frequency of the power output from the generator will therefore be variable, which is unsatisfactory for many applications. The power conditioning electronics are capable of adapting the variable frequency input to a fixed frequency output suitable for the application; this may be to the utility grid or for local consumption. The electronics are also capable of controlling the torque reacted by the coils in the generator by controlling the load, which provides a power tracking function and an active stall feature.

The basic power conditioning circuit is shown in FIG. 7a. Three-phase output from the generator 701 is provided to a rectifier 702 (including a DC/DC converter to regulate the DC link voltage). The rectifier is a 3-phase bridge rectifier. The DC output of the rectifier 702 is fed to an active inverter 703, with an output 706 of fixed frequency. A single phase inverter has four active switches 703a-d, which can be any type of active switch, including insulated gate bipolar transistors (IGBT), bipolar junction transistors, field effect transistors etc. Other types of inverter could be used. For example, where power levels are greater than 5 kW a three-phase inverter would be used. The switches 703a-d are controlled by a pulse width modulator 705 which provides pulses of predetermined length and duration to each switch. The length, duration and sequence of pulses provided to the switches of the inverter determine the frequency of the power output and also the power provided by the generator 104. See for example N. Mohan, T. M. Undeland and W. P. Robins, Power Electronics: Converters, Applications and Design, John Wiley & Sons, 2003. Power output can therefore be controlled by the pulse characteristics provided by the pulse width modulator; where speed is constant, power output is directly proportional to the torque reacted by the generator and therefore the speed of rotation of the blades is controllable by the pulses applied to the switches 703a-d. A controller 704 is provided which monitors one or more of the input phases 701 for power magnitude and frequency. The controller is connected to the pulse width modulator 705 which controls the parameters of the output pulses.

FIG. 7b shows a multi-level converter (for one phase of the load) suitable for conditioning the output power from a multiple isolated winding coil configuration. As discussed supra, with reference to FIGS. 12 and 13 in particular, such a multi-level configuration has the added advantage of requiring a smaller output filter. Three sets, or groups, G₁, G₂, and G₃ of three phase inputs are shown in the embodiment of FIG. 7b. Each input group is connected to a rectifier and an inverter. For a stator with 36 teeth this means that there are 3 groups of 12 connected coils with 3 outputs. Again, the idea can be extended to multiple sets or groups of M-phase windings.

There are also other benefits to splitting the windings into several sets of m-phase windings.

The power rating of each winding is a smaller share of the total power. For example if there are two sets of m-phase windings, each will supply half of the total rated power of the machine. Accordingly, the ratings of the rectifiers will be smaller. This provides a solution for high power low voltage generators, with high current that cannot be handled by single rectifier diodes.

An additional benefit can be derived from the fact that each set of m-phase windings is electrically isolated from the other, thus enabling the generation of electrically isolated dc voltages, to supply multi-level inverters (dc/ac converters), such as the cascaded H-bridge inverter (703) shown in FIG. 7. Normally, a transformer is used to produce the electrically isolated output. Multi-level inverters bring their own benefits in terms of reducing the output filter requirements.

Instead of the passive rectifier using diodes as shown in FIGS. 10 and 12, active rectifiers using transistors could be employed, and the above benefits will still apply.

A controller (not shown) monitors the input frequency from one or more inputs in order to determine the rotation speed of the turbine and monitors the output power. For the generator described above, rotation of the blades at 100 rpm equates to a tip speed of 11 m/s and can produce 10 kW of power.

If a sudden drop in power is detected, indicating failure of a coil, the controller can modify the control signals produced by a pulse width modulator to compensate for the loss, by increasing the load on the remaining groups

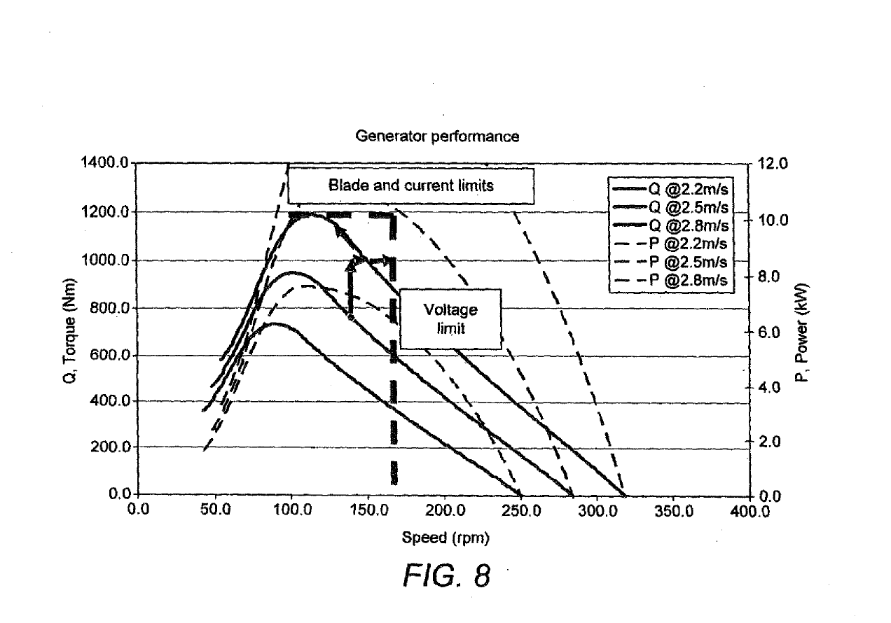

In use, where there is no fluid flow the turbine blades are at rest. As the flow rate increases, the pressure on the turbine blades builds until it is sufficient to overcome the cogging torque and the blades begin to turn. The power generated is proportional to cube of the flow speed and for a given flow speed and blade pitch there is an optimum turbine rotation speed to achieve maximum power output. FIG. 8 shows how the torque Q and power available P is dependent on the rotational speed of the turbine for specific flow rates. It can be seen that for low rotational speeds, the power available is low but as the rotational speed increases the power output increases sharply to a maximum. For flow rates of 2.2 m/s the maximum occurs at around 90 rpm. For flow rates of 2.8 m/s the maximum is at 110 rpm. Above this maximum the power falls off, eventually becoming zero at very high speeds. The controller 704 constantly measures the voltage and current of a coil. During start-up, as the blades begin to rotate, no power is drawn which allows the blades to reach a minimum working speed and to prevent stalling of the turbine. When the blades reach a minimum working speed the controller 704 sends appropriate signals to the pulse width modulator 705 and power is drawn from the coils. The controller measures the change in current and voltage and the frequency of the supply to track the maximum power available, ensuring that the generator is always operated around the maximum of the curve in FIG. 8. If the controller 704 detects that the output power is increasing with increasing frequency (i.e. blade rotation speed is increasing) the controller 704 determines that the maximum has not yet been reached and instructs the pulse width modulator 705 accordingly, i.e. to produce output signals to control the inverter 703 to draw more power. If the controller 704 determines that the change in power is decreasing with increasing frequency, the controller 704 determines that the maximum has been passed and it sends a control signal to the pulse width modulator 705 to gradually increase the reacted torque to bring the speed of rotation of the turbine down to regain the maximum. Then, when it is detected that the power is starting to fall off with decreasing frequency the controller determines that the generator is off-maximum and the power drawn is increased. This procedure is constantly performed to track the maximum power output.

When the maximum power tracking is operational there is a possibility that the safe working speed of the turbine generator will be exceeded and therefore an active stall feature is included to stall the turbine in extreme operating conditions. The current and voltage produced by the stator coils increases proportionally with the stream speed of the water flow. However, the coils of the stator and the power conditioning electronics have a maximum safe working limit and the blades will have a maximum rotational speed above which the risk of breakage becomes high. To maintain safe operation, when the flow speed increases above a safe limit the turbine can be stalled. If the controller 704 determines that the frequency or power generated has reached a pre-set value, indicating excessive stream speed, a signal is sent to the pulse width modulator 705 to increase the output power rapidly. This reacts torque on the generator and will stop rotation of the turbine altogether.

Heat generated by the generator is conducted away through the structure and dissipated into the water flowing past the generator.

A permanent magnet synchronous generator is described above. However, other types of generator may be used, for example reluctance, dc or induction generators. The permanent magnets may be replaced with electromagnets.

The control electronics may be located within the stator cavity so that the turbine generator is self contained. Alternatively the control electronics may be provided remotely, for example on the supporting structure.

The turbine generator may be supported by a single support as shown in FIG. 5.

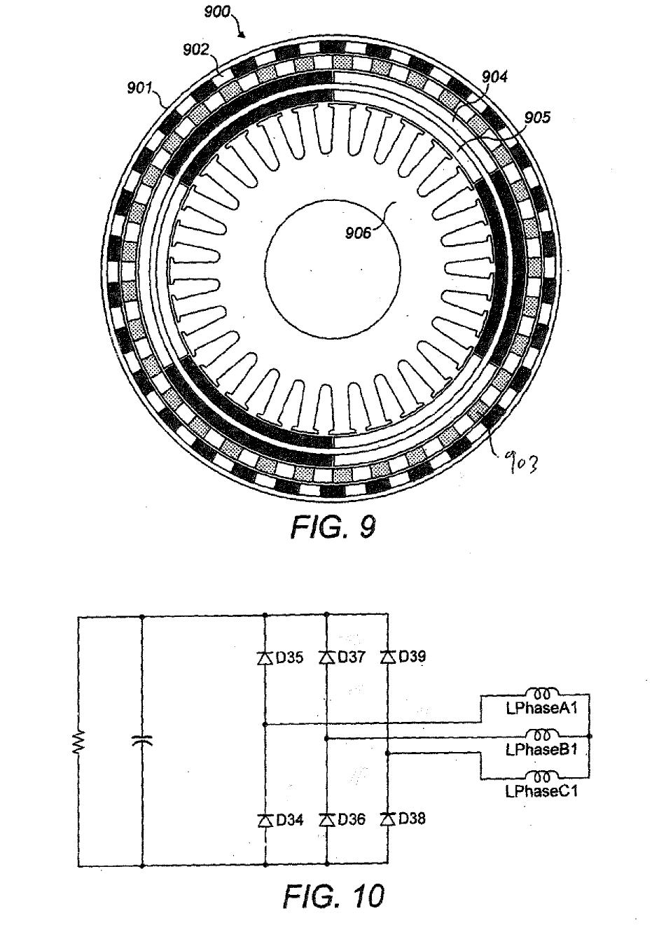

In an alternative embodiment the turbine generator can additionally incorporate a magnetic gear assembly. The magnetic gear assembly can be used to increase the speed and reduce the torque of the generator rotor arranged to rotate about the stator core thereby reducing the effective size of the turbine generator. An embodiment of a generator turbine 900 incorporating a magnetic gear assembly is shown in FIG. 9. High speed magnets of the magnetic gear are mounted circumferentially around the internal surface of the rotatable hub 901 to form an outer gear rotor 902 which, being attached to the rotatable hub, is operable to rotate with the hub at a low speed relative to the generator rotor 905. The low speed rotation of the outer gear rotor 902 is translated into higher speed and lower torque motion of the generator rotor 905 by an array of complementary stationary ferromagnetic (e.g. steel) pole pieces 903 and a rotating inner gear rotor 904 of the magnetic gear assembly.

Magnets positioned on the outer gear rotor 902 are arranged to interact with magnets on a faster rotating inner gear rotor 904 through the array of stationary ferromagnetic (e.g. steel) pole pieces 903. The magnets of the inner gear rotor 904 are preferably arranged circumferentially on an outer surface of a freely rotatable ferromagnetic cylinder which surrounds the stator core 906. The generator rotor 905 comprises magnets which are mounted on the inner surface of the ferromagnetic cylinder. Thus, the generator magnets and the magnets of the inner gear rotor rotate together with the rotatable ferromagnetic cylinder. The ferromagnetic cylinder is provided with appropriately positioned bearings arranged to permit free rotation within the hub. This is shown in FIG. 9 where the generator rotor 905 has an equal number of magnets to the inner gear rotor 904.

The ferromagnetic pole pieces 903 are positioned within the magnet assembly between the inner and outer gear rotors 902, 904 and modulate the flux density of the magnets of the inner and outer gear rotors 902, 904 such that each sees a harmonic of the flux of other magnets of the same pole number. This magnetic interaction permits gearing up or down of the rotational motion of the outer gear rotor (i.e. the rotational outer hub).

The gear ratio is determined according to the following formula described in K. Atallah and D. Howe, “A novel high-performance magnetic gear,” IEEE Transactions on Magnetic, Vol. 37, No. 4, pp. 2844-2846, 2001 (which is hereby incorporated by reference):

$$G = \frac{mP}{mP + {kn}_{s}}$$

where P is the number of pole pairs on the high-speed rotors of the magnetic gear, m=1, 2, 3, . . . and k=0±1±2± . . . , and nₛ is the number of ferromagnetic pieces. The combination of m=1 and k=−1 gives the largest harmonic and hence the highest transmission torque. Using the above formula with m=1 and k=−1 the magnetic gear ratio for the generator shown in the drawing in FIG. 9 can be calculated as G=3/(3−33)=−1110, i.e. a ratio of 1:10 with the inner and outer rotors rotating in opposite directions. An engineer or designer can calculate the number of intermediary ferromagnetic pole pieces required from G (negative value) and P by re-arranging the above equation in terms of nₛ where

$${n}_{s} = P - \frac{P}{G}$$

Taking P=3 as the number of poles on the inner rotor and the gearing ratio G=−1/10 this gives nₛ=33.

In an alternative embodiment (not shown) the inner gear rotor 904 can, in addition to forming part of the magnetic gear assembly, also act as the generator rotor 905. Accordingly, in this embodiment the magnets of the outer gear rotor 902 effectively directly interact with those of the generator rotor/inner gear rotor 905 to provide the increase in speed and associated reduction in torque. This has the advantage of few components but the disadvantage is that the interaction between the inner gear rotor/generator rotor and the outer gear will be weaker and hence the torque capability reduced.

In the above embodiments the described turbine is a water turbine for generating electricity from a flow of water aligned with the rotational axis of the turbine. However, as set out in the introduction, the present invention is also applicable to wind turbines. By extending the length of the blades the generator may be used to convert wind energy to electricity. The turbine generator can, for example, be positioned atop a wind tower and the direct drive generator used to generate electricity.

Typically a wind turbine has a high torque and low speed rotor in order to efficiently convert the wind energy into the mechanical rotational energy of the turbine. In conventional wind turbines the rotors would actuate an external generator which would be provided with a mechanical gear box to convert the low speed, high torque rotational motion into high speed, low torque motion suitable for a generator. This keeps the overall size and cost of the generator down.

In applying the turbine generator of the present invention for wind it is preferable to use the magnetic gearing described above in relation to the water turbine to convert the low speed, high torque rotations of the wind turbine into relatively high speed, lower torque rotation suitable for an electrical generator. The magnetic gear assembly would be arranged to have the inner gear rotor rotate faster than the outer gear rotor mounted onto the rotatable hub. This can be achieved by having more magnets on the outer gear rotor than the inner gear rotor, preferably in accordance with the relation already described above in connection with the water turbine magnetic gear assembly. This arrangement permits the generator size to be small because of the reduced torque load and therefore reduce the overhung mass that would implicitly result from incorporating the generator into the head of the wind turbine.

The support structure of such a wind turbine would preferably be modified to provide support at both ends of the stator structure. In one embodiment this support structure would be similar to the support structure for the marine turbine generator shown in FIGS. 1a to 1c already described above. In other embodiments the turbine tower itself could provide the support at one end of the stator thereby requiring only one further support strut at the overhanging end of the stator. Alternatively, or in addition to a support structure, the wind turbine could be strengthened structurally in order to bear the load of the over hung mass of the generator. In a further alternative two contra rotating (i.e. rotating in different directions) turbines could be placed either side of the wind tower

It is to be understood that various modifications to the preferred embodiment and the generic principles and features described herein will be readily apparent to those skilled in the art.

1. A turbine generator for generating electrical power from flowing fluid comprising:
a rotatable hub having an external surface and a rotational axis arranged, in use, parallel to the direction of the flow;
a plurality of blades mounted on the external surface of the hub and extending radially outwards from the hub;
a plurality of magnets mounted on a surface inside the rotatable hub, said surface arranged to rotate with the rotatable hub thereby forming a rotor of an electrical generator; and
a plurality of non-rotating coils fixed to a stationary cylindrical core within the periphery of the rotatable hub, said coils and core thereby forming a stator of the electrical generator,
wherein the plurality of coils are connected to form multiple separate groups of coils to provide an m-phase output, and wherein the plurality of coils are further connected to form a plurality of separate isolated sets of said multiple groups of coils so as to provide a corresponding plurality of m-phase outputs.

2. A turbine generator in accordance with claim 1, wherein the plurality of separate isolated sets is connected to independent power electronic converters that may be connected in series or parallel.

3. A turbine generator in accordance with claim 2, wherein the power electronic converters comprise rectifiers.

4. A turbine generator in accordance with claim 3, wherein the plurality of coils are connected to form three separate groups of coils to provide a three phase output.

5. A turbine generator in accordance with claim 4, wherein the plurality of coils is configured such that there are two isolated sets of coils generating outputs phase-shifted by 30 degrees and respectively connected to two 6-pulse rectifiers to result in a rectified output having 12 pulses every cycle.

6. A turbine generator according to claim 1 wherein the flowing fluid comprises water or air.

7. A turbine generator in accordance with claim 1, wherein the magnets comprise permanent magnets.

8. A turbine generator in accordance with claim 1, wherein the blades each comprise two aerofoil sections arranged back to back to form a peanut-shaped cross-sectional profile where each aerofoil section will generate lift in a particular direction of rotation such that they are rotationally symmetrical and the turbine generator operates efficiently in both forward and reverse fluid flow thereby permitting bi-directional operation.

9. A turbine generator in accordance with claim 1, wherein the stator and the rotor are arranged so that a gap is formed between that is able to be filled with fluid.

10. A turbine generator in accordance with claim 9, wherein the fluid comprises oil.

11. A turbine generator in accordance with claim 9, wherein the fluid comprises fluid, for example water, from the fluid flow.

12. A turbine generator in accordance with claim 8, further comprising a waterproof layer arranged to encapsulate the stator and rotor to seal them against the fluid in the gap.

13. A turbine generator in accordance with claim 1 further comprising a frame arranged to support both ends of the stator.

14. A turbine generator in accordance with claim 1, further comprising a support arm arranged to support one end of the stator.

15. A turbine generator in accordance with claim 1, wherein the cylindrical core of the stator is hollow and defines a cavity within the cylindrical core.

16. A turbine generator in accordance with claim 15, wherein the cavity is arranged to provide a thermal expansion chamber for fluid in the gap between the stator and the rotor.

17. A turbine generator in accordance with claim 15, wherein the cavity is air-filled or foam-filled.

18. A turbine generator in accordance with claim 15, wherein the cavity is configured to house control electronics.

19. A turbine generator in accordance with claim 1, wherein the core is laminated and the laminations comprise an edge-wound spiral strip of steel.

20. A turbine generator in accordance with claim 1, wherein the core further comprises a plurality of slots on its outer surface running in an axial direction, wherein each portion of the core between adjacent slots forms a raised tooth and each of the plurality of coils are wound around one or more of the raised teeth.

21. A turbine generator in accordance with claim 20, wherein the slots are skewed.

22. A turbine generator in accordance with claim 7, wherein the magnets are skewed.

23. A turbine generator according to any preceding claim 1 wherein the rotatable hub has an internal surface and the magnets are mounted on the internal surface of the rotatable hub.

24. A turbine generator according to claim 1, further comprising a magnetic gear assembly arranged about the generator rotor operable to gear-up rotation of the generator rotor with respect to rotations of the rotating hub.

25. A turbine generator according to claim 24, wherein said magnetic gear assembly comprises:
a plurality of stationary ferromagnetic pole pieces disposed between the generator rotor and the outer hub; and
a gear outer rotor, comprising a plurality of gear outer rotor magnets, arranged on the internal surface of the rotatable hub; wherein
the number of generator rotor magnets is less than the number of gear outer rotor magnets.

26. A turbine generator according to claim 25 wherein the gear outer rotor magnets are arranged to interact with the generator rotor magnets through the stationary ferromagnetic pole pieces of the generator rotor such that the generator rotor rotates with an increased speed and lower torque than the gear outer rotor thereby gearing-up rotation of the generator rotor with respect to rotations of the rotating hub.

27. A turbine generator according to claim 25 wherein said magnetic gear assembly further comprises:
a gear inner rotor comprising a plurality of gear inner rotor magnets, disposed between the generator rotor and the stationary ferromagnetic pole pieces; and
wherein the gear inner rotor magnets are arranged to interact with the gear outer rotor magnets through the stationary ferromagnetic pole pieces such that the gear inner rotor rotates at a greater speed and lower torque than the gear outer rotor; and
the generator rotor is connected to the gear inner rotor such that the generator rotor rotates with the gear inner rotor thereby gearing-up rotation of the generator rotor with respect to the rotations of the rotating hub.

28. A turbine generator according to claim 24 wherein the number of magnets in the magnetic gear assembly adheres to the relationship:
$$G = \frac{mP}{mP + {kn}_{s}}$$
where G is a predetermined gearing ratio, P is the number of magnet pole-pairs on a rotor of the magnetic gear, m=1, 2, 3, . . . and k=0±1±2± . . . , and nₛ is the number of ferromagnetic pieces.

29. A turbine generator in accordance with claim 1, further comprising generator control means comprising:
a coil power output monitoring means for monitoring the power output of at least one of the coils; and
a control unit for controlling the reacted torque to the coils in dependence on the output of the monitoring means to maximise the power output for a given water flow rate and/or to stall the turbine if a maximum rotational speed is exceeded.

30. A method of operating a turbine generator as claimed in any preceding claim 1, comprising:
measuring a change in output power produced by at least one coil of the generator thereby determining whether the output power is increasing;
measuring the speed of rotation of the rotor of the generator; and
tracking the maximum output power by drawing more power from the generator coils if it is determined that the output power is increasing with increasing or decreasing rotor speed.

31. A method of operating a turbine generator in accordance with claim 30, further comprising increasing the output power rapidly in order to stall the turbine if the output power or rotor speed exceed a predetermined value.
